(19) United States
(12) Patent Application Publication
(10) Pub. No.: US 2025/0056565 A1
(43) Pub. Date: Feb. 13, 2025

(54) METHOD, DEVICE AND COMPUTER PROGRAM PRODUCT FOR WIRELESS COMMUNICATION

(71) Applicant: ZTE CORPORATION, Shenzhen (CN)

(72) Inventors: Qiujin GUO, Shenzhen (CN); Mengzhu CHEN, Shenzhen (CN); Bo DAI, Shenzhen (CN); Jun XU, Shenzhen (CN); Youjun HU, Shenzhen (CN); Xuan MA, Shenzhen (CN); Xiaoying MA, Shenzhen (CN); Hong TANG, Shenzhen (CN); Jianqiang DAI, Shenzhen (CN)

(73) Assignee: ZTE CORPORATION, Shenzhen (CN)

(21) Appl. No.: 18/930,535

(22) Filed: Oct. 29, 2024

Related U.S. Application Data
(63) Continuation of application No. PCT/CN2022/111910, filed on Aug. 11, 2022.

(51) Int. Cl. H04W 72/232; H04W 76/28

(52) U.S. Cl. CPC H04W 72/232; H04W 76/28

(57) ABSTRACT

A wireless communication method is disclosed. The method comprises: receiving, by a wireless communication terminal from a wireless communication node, indication information of one or more downlink, DL, signal transmissions, wherein the indication information indicates one or more transmission patterns for the one or more DL signal transmissions; and receiving, by the wireless communication terminal from the wireless communication node, one or more DL signals according to the one or more patterns for the one or more DL signal transmissions.

### CROSS-REFERENCE TO RELATED APPLICATION

This application claims the benefit of priority under 35 U.S.C. § 120 as a continuation of International Patent Application No. PCT/CN2022/111910, filed on Aug. 11, 2022, the disclosure of which is incorporated herein by reference in its entirety.

### TECHNICAL FIELD

This document is directed generally to wireless communications, in particular to 5th generation (5G) or 6th generation (6G) wireless communication.

### BACKGROUND

In 5G NR (new radio) technology, there are some always-on signals which may consume power even though these signals are transmitted with a long periodicity (e.g., a maximum periodicity of 160 milliseconds (ms)), during micro-sleep TX (transmit, transmission or transmitter), and in a low traffic load scenario. However, based on actual requirements, most of the transmissions are unnecessary.

### SUMMARY

The present disclosure relates to methods, systems, and devices for downlink signal transmissions.

One aspect of the present disclosure relates to a wireless communication method. In an embodiment, the wireless communication method includes: receiving, by a wireless communication terminal from a wireless communication node, indication information of one or more downlink, DL, signal transmissions, wherein the indication information indicates one or more transmission patterns for the one or more DL signal transmissions; and receiving, by the wireless communication terminal from the wireless communication node, one or more DL signals according to the one or more patterns for the one or more DL signal transmissions.

Another aspect of the present disclosure relates to a wireless communication method. In an embodiment, the wireless communication method includes: transmitting, by a wireless communication node to a wireless communication terminal, indication information of one or more downlink, DL, signal transmissions, wherein the indication information indicates one or more transmission patterns for the one or more DL signal transmissions; and transmitting, by the wireless communication node to the wireless communication terminal, one or more DL signals according to the one or more patterns for the one or more DL signal transmissions.

Another aspect of the present disclosure relates to a wireless communication terminal. In an embodiment, the wireless communication terminal includes a communication unit and a processor. The processor is configured to: receive, from a wireless communication node, indication information of one or more downlink, DL, signal transmissions, wherein the indication information indicates one or more transmission patterns for the one or more DL signal transmissions; and receive, from the wireless communication node, one or more DL signals according to the one or more patterns for the one or more DL signal transmissions.

Another aspect of the present disclosure relates to a wireless communication node. In an embodiment, the wireless communication node includes a communication unit and a processor. The processor is configured to: transmit, to a wireless communication terminal, indication information of one or more downlink, DL, signal transmissions, wherein the indication information indicates one or more transmission patterns for the one or more DL signal transmissions; and transmit, to the wireless communication terminal, one or more DL signals according to the one or more patterns for the one or more DL signal transmissions.

Various embodiments may preferably implement the following features:

Preferably or in some embodiments, the indication information comprises at least one of:
an indication of an availability or unavailability of one or more validity durations for the one or more DL signal transmissions;
an indication of an availability or unavailability of one or more DL signal bursts;
a change of the one or more DL signal transmissions;
a configuration of the one or more DL signal transmissions;
a value of a validity duration or an invalid duration;
a start position of the validity duration;
a gap for ignoring the one or more DL signal transmissions;
a periodicity or duration for the one or more DL signal transmissions;
a start offset of the validity duration or a periodicity for the one or more DL signal transmissions;
a number of available or unavailable DL signals;
a resource set for the one or more DL signal transmissions;
a paging occasion, PO, offset for the one or more DL signal transmissions;
a value of a system frame number, SFN, or a value of a paging frame, PF, index as a reference point of a valid time for the one or more DL signal transmissions;
an index of a pattern among the one or more patterns for the one or more DL signal transmissions;
a de-activation or unavailability of one or more validity durations or periodicities for the one or more DL signal transmissions;
an indication of no transmission of the one or more DL signals;
a stop or unavailability of at least one of the one or more DL signals; or
a hybrid automatic repeat request acknowledgment, HARQ-ACK, feedback for receiving the indication information.

Preferably or in some embodiments, the value of PF index is not larger than a value of an Extended Discontinuous Reception, eDRX, cycle or a default paging cycle over 10 milliseconds.

Preferably or in some embodiments, the one or more DL signals comprises at least one of:
a Synchronization Signal Block, SSB;
a cell defining, CD, SSB or non cell-defining, NCD, SSB;
an SSB being available during a validity duration for the wireless communication terminal;
a Primary Synchronization Signal, PSS, or Secondary Synchronization Signal, SSS;
a Tracking Reference Signal, TRS;
a channel status information reference signal, CSI-RS; or
a paging signal.

Preferably or in some embodiments, the one or more DL signals are used for at least one of: a synchronization, an automatic gain control, AGC, adjustment, a beam management, a beam sweeping, a channel status information, CSI, measurement, a radio link monitoring measurement, a Radio Resources Management, RRM, measurement, or an energy saving for the wireless communication node.

Preferably or in some embodiments, the one or more transmission patterns comprises at least one of:
a valid time or invalid time;
a validity duration;
a start position or a boundary of the validity duration;
a modification period for the one or more DL signal transmissions;
a DL signal transmission occasion; or
a resource set.

Preferably or in some embodiments, the valid time or invalid time is determined based on at least one of: a start point, an end position, a duration of the valid time or invalid time, a Discontinuous Reception, DRX, cycle, an indication of an availability of a validity duration or available DL signals, or an indication of an unavailability of a validity duration or unavailable DL signals.

Preferably or in some embodiments, at least one of the start point or the end position is determined based on at least one of a PF offset, a periodicity for the one or more DL signal transmissions, an eDRX cycle, a default paging cycle, a DRX cycle, or a modification period.

Preferably or in some embodiments, the duration of the valid time or invalid time is determined based on at least one of: a multiple of a periodicity or a validity duration for the one or more DL signal transmissions, or a certain number of sequential symbols or slots.

Preferably or in some embodiments, the validity duration is a number of eDRX cycles, default paging cycles, or DRX cycles.

Preferably or in some embodiments, a start position of the validity duration is determined based on at least one of: a position of a first PF during an eDRX cycle or a paging cycle, a predetermined system frame number, SFN, or a delay after a reception of the indication information.

Preferably or in some embodiments, a boundary of the validity duration is determined based on at least one of: a gap or a position that receiving the indication information of the one or more DL signal transmissions.

Preferably or in some embodiments, a period before a PF, PO, SFN, slot, or symbol that the wireless communication terminal receives the indication information of the one or more DL signal transmissions, and the wireless communication terminal is not allowed to receive the one or more DL signals in the gap.

Preferably or in some embodiments, the wireless communication terminal receives a configuration of the one or more DL signal transmissions in a first modification period, receives the indication information in a second modification period adjacent to the first modification period, and receives the one or more DL signals in a third modification period adjacent to the second modification period.

Preferably or in some embodiments, a boundary of the modification periods is determined based on at least one of a period value or an offset.

Preferably or in some embodiments, a boundary of the DL signal transmission occasion is determined based on a PO offset.

Preferably or in some embodiments, the resource set comprises at least one of: a first resource set for a basic pattern, a second resource set for a normal pattern, a third resource set for a pattern configured by a system information block, SIB, or a fourth resource set for a user equipment, UE, specific pattern.

Preferably or in some embodiments, at least one of the first or third resource set is determined based on at least one of: a validity duration, a start position of validity duration, a number of available DL signals, a PO offset, or a modification period.

Preferably or in some embodiments, at least one of the first or third resource set is configured for a UE in an idle-mode.

Preferably or in some embodiments, at least one of the second or fourth resource set is determined based on at least one of: a validity duration, a start position of validity duration, a number of available DL signals, a PO offset, a modification period, a DRX cycle, a periodicity, or a duration.

Preferably or in some embodiments, at least one of the second or fourth resource set is configured for a UE in a connected-mode.

Preferably or in some embodiments, the indication information is indicated by at least one of: Cell-specific DCI, Group-common DCI, UE-specific DCI, a Medium Access Control Control Element, MAC CE, Radio Resource Control, RRC, signaling, or an SIB.

Preferably or in some embodiments, the Cell-specific DCI comprises at least one of: an information block comprising an indication for the one or more DL signal transmissions for all UEs in one or more cells or one or more cell groups, a bitmap field comprising one or more indications for the one or more DL signal transmissions for all UEs in one or more cells or one or more cell groups, or an indication field comprising an indication for the one or more DL signal transmissions for all UEs in a cell or a cell group.

Preferably or in some embodiments, the one or more cell groups supports at least one of: same eDRX parameters, a same default paging cycle, or a same DRX cycle.

Preferably or in some embodiments, the Group-common DCI comprises at least one of:

an information block configured for a UE in a group of UEs; an information block configured for a group of UEs; or a bitmap, wherein each bit is configured for one or more groups of UEs.

Preferably or in some embodiments, the group of UEs supports at least one of: having valid POs in a same PF, or having valid POs in a number of sequential PF during an eDRX cycle or a default paging cycle.

Preferably or in some embodiments, the Group-common DCI indicates the indication information in at least one field of: a slot format indicator, an available resource block, RB, set indicator, or a channel occupancy time, COT, duration indicator, a search space set group switching flag, a pre-emption indication, a wake-up indication, a secondary cell, SCell, dormancy indication, a paging indication, or a TRS availability indication.

Preferably or in some embodiments, the UE-specific DCI comprises at least one of: a bitmap to indicate an availability of one or more validity durations or periodicities for the one or more DL signal transmissions, or an indication field indicating at least one of: a reference point, a start SFN, a slot, a symbol for a validity duration or the DL signal transmission.

Preferably or in some embodiments, the UE-specific DCI indicates the indication information in at least one field of: a frequency domain resource assignment, a time domain resource assignment, a modulation and coding scheme, a new data indicator, a redundancy version, an HARQ process number, an uplink or supplementary uplink, UL/SUL, indicator, an HARQ-ACK bitmap, an indicator of all remaining bits used for configured grant downlink feedback information, CG-DFI, a redundancy version, a random access preamble index, a synchronization signal/physical broadcast channel, SS/PBCH, index, a physical random access channel, PRACH, mask index, reserved bits, a downlink assignment index, a physical uplink control channel, PUCCH, resource indicator, a field of short messages, a TRS availability indication, a physical downlink shared channel, PDSCH, group index, an HARQ-ACK retransmission indicator, or an SCell dormancy indication.

Preferably or in some embodiments, the RRC signaling comprises at least one of: parameters of the one or more DL signal transmissions configured for a cell or a group of cells, or parameters of the one or more DL signal transmissions configured for a UE or a group of UEs.

Preferably or in some embodiments, the SIB comprises at least one of:
an index of one of the one or more DL signals;
an availability of one or more validity durations of the one or more DL signal transmissions;
an availability of at least one of the one or more DL signals;
parameters associated with DL signal transmission occasions;
a number of RBs or orthogonal frequency-division multiplexing, OFDM, symbols occupied by the one or more DL signals;
a periodicity or duration for the one or more DL signal transmissions;
a start offset for a validity duration or a periodicity for the one or more DL signal transmissions;
a start position or reference point for a validity duration or for the one or more DL signals;
an indication indicating whether the one or more DL signal transmissions are configured, started, or stopped;
an indication indicating whether the one or more DL signal transmissions are valid; or
an indication indicating whether another signal transmission is deactivated.

Preferably or in some embodiments, in response to that the wireless communication terminal receives a configuration of the one or more DL signal transmissions and the wireless communication terminal does not receive the indication information associated with the one or more DL signal transmissions in a predefined resource, the wireless communication terminal performs at least one of:
performing operations relating to that the one or more DL signal transmissions are not available during a specific resource;
performing operations relating to that the one or more DL signal transmissions are available during a specific resource; or
performing operations relating to that the one or more DL signal transmissions are available or not available during a specific resource based on a higher layer parameter.

Preferably or in some embodiments, in response to that the wireless communication terminal receives a configuration of the one or more DL signal transmissions and the wireless communication terminal does not receive an associated with the one or more DL signal transmissions in the modification period, the wireless communication terminal performs at least one of:
keeping acquiring SIB information during a next sequential modification period; or
performing operations relating to that the one or more DL signal transmissions are available during a specific resource; or
stopping acquiring SIB information and performing operations relating to that the one or more DL signal transmissions are not available.

Preferably or in some embodiments, in response to that the wireless communication terminal is configured with a change of the one or more DL signal transmissions, and the wireless communication terminal does not receive information associated with the one or more DL signal transmissions from an acquired SIB during a modification period after another modification period where system information of the change or a DL signal transmission configuration is received, the wireless communication terminal performs at least one of:
keeping acquiring SIB information during a next sequential modification period; or
stopping acquiring SIB information and performing operations relating to that the one or more DL signal transmissions are not available.

Preferably or in some embodiments, in response to that the wireless communication terminal is configured with the one or more DL signal transmissions, the wireless communication terminal does not receive any DL signal during a valid time for the one or more DL signal transmissions, the wireless communication terminal performs at least one of:
using a configuration of a last recent transmission or measurement of another DL signal in a PDCCH or PDSCH reception;
using a default pattern or a default configuration for the one or more DL signal transmissions; or
receiving the one or more DL signals during one or more additional validity durations or periodicities or modification periods.

Preferably or in some embodiments, a priority level for the one or more DL signal transmissions is configured for collisions between the one or more DL signal transmissions and other signals or channels.

Preferably or in some embodiments, the wireless communication terminal supports at least one of: the one or more DL signal transmissions, a request or feedback for a DL signal transmission configuration, or an SCell without SSB for an inter-band carrier aggregation, CA.

Preferably or in some embodiments, the DL signals comprise a cell defining SSB, CD-SSB, and a non cell defining SSB, NCD-SSB, the transmission pattern comprises an offset between the CD-SSB and the NCD-SSB.

Preferably or in some embodiments, the offset comprises at least one of:
{sf30, sf40, sf60, sf80, sf120}, or
{¼, ½, ¾}, or
{sf30, sf40, sf60, sf80, sf120, ¼, ½, ¾}.

Preferably or in some embodiments, the offset comprises:
{sf5, sf10, sf15, sf30, sf40, sf60, sf80, sf120},
{sf5, sf10, sf15, sf30, sf60, spare3, spare2, spare1}, or
{sf5, sf10, sf15, sf30, sf60, sf120, spare2, spare1}, or
{sf5, sf10, sf15, ¼, ½, ¾, spare2, spare1}, or
{sf5, sf10, sf15, ½, ¾, spare3, spare2, spare1}.

Preferably or in some embodiments, the wireless communication node transmits a configuration of the one or more DL signal transmissions to the wireless communication terminal in a first modification period, transmits the indication information in a second modification period adjacent to the first modification period, and receives the one or more DL signals in a third modification period adjacent to the transmits modification period.

The example embodiments disclosed herein are directed to providing features that will become readily apparent by reference to the following description when taken in conjunction with the accompany drawings. In accordance with various embodiments, example systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the example embodiments and applications described and illustrated herein. Additionally, the specific order and/or hierarchy of steps in the methods disclosed herein are merely example approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

The above and other aspects and their implementations are described in greater detail in the drawings, the descriptions, and the claims.

### BRIEF DESCRIPTION OF THE DRAWINGS

FIG. 1 shows an example of a transmission pattern in accordance with an embodiment of the present disclosure.

FIG. 2 shows an example of a transmission pattern in accordance with another embodiment of the present disclosure.

FIG. 3 shows an example a transmission pattern according to another embodiment of the present disclosure.

FIG. 4 shows an example of a transmission pattern according to another embodiment of the present disclosure.

FIG. 5 shows an example of a transmission pattern according to another embodiment of the present disclosure.

FIG. 6 shows an example of a transmission pattern according to another embodiment of the present disclosure.

FIG. 7 shows an example of a transmission pattern according to another embodiment of the present disclosure.

FIG. 8 shows an example of a transmission pattern according to another embodiment of the present disclosure.

FIG. 9 shows an example of a transmission pattern according to another embodiment of the present disclosure.

FIG. 10 shows an example of a transmission pattern according to another embodiment of the present disclosure.

FIG. 11 shows an example of a transmission pattern according to another embodiment of the present disclosure.

FIG. 12 shows an example of a transmission pattern according to another embodiment of the present disclosure.

FIG. 13 shows an example of a transmission pattern according to another embodiment of the present disclosure.

FIG. 14 shows a schematic diagram of a wireless communication terminal according to an embodiment of the present disclosure.

FIG. 15 shows a schematic diagram of a wireless communication node according to an embodiment of the present disclosure.

### DETAILED DESCRIPTION

In some embodiments, switching to a sleep mode and/or turning off some RF components when they are not needed are effective methods to reduce the network power consumption. For example, if there is no UE access, the carrier can be deactivated. When the traffic load is low, the number of the Tx/Rx (transmission/reception) antennas can be reduced.

However, in some approaches, there are some problems with this energy saving method. First, there are some common signals and necessary communications, such as the SSB (Synchronization Signal Block), SIB1 (System Information Block), paging, and PRACH (Physical Random Access Channel) receptions, so that the network cannot easily enter the low power consumption state, e.g., the sleep mode. Secondly, even if the devices can enter sleep states, it is a problem to wake up the devices. If a semi-static configuration is used, the devices can be awakened only after sleeping for a certain period of time. If there is a service requirement in the sleeping state, the device cannot meet the requirement, which will cause a great delay and affect the user experience.

In some embodiments, to reduce the power consumption of communication systems, the network may be able to enter the low power consumption state as long as possible. In addition, a more dynamic wake-up mechanism may be introduced to meet the flexible service requirements and minimize the impact on the user experience.

Many embodiments of the present disclosure are described below, but the present disclosure is not limited there to. In particular, as used herein, including in the claims, “or” as used in a list of items (e.g., a list of items prefaced by a phrase such as “at least one of” or “one or more of”) indicates an inclusive list such that, for example, a list of at least one of A, B or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”.

In the following paragraphs, a design on at least one DL (downlink) signal transmission and the related triggering methods in some embodiments of the present disclosure are described to achieve power saving without increasing the UE (user equipment) power and degrading the experience.

In an embodiment, the base station (BS) may be a communication node, or BTS (Base Transceiver Station) in 2G (2^{nd} generation) wireless communication, or NodeB in 3G (3^{rd} generation) wireless communication, or eNB (E-UTRAN NodeB/enhanced NodeB) in 4G (4^{th} generation) wireless communication, or gNB in 5G wireless communication, or a base station of LTE (Long term evolution) or NR (New Radio access technology), or a base station of a further generation communication system, or a cell with a normal state or activated state or deactivated state or dormant state, or a cell providing a basic coverage, or a cell boosting the capacity, or a small cell, or a primary cell, or a secondary cell.

Some aspects of the present disclosure are described below, but the present disclosure is not limited thereto. The aspects may include (1) the indication information for the DL signal transmission, (2) the DL signals, (3) the patterns for the DL signal transmission, (4) the indication/configuration signaling, (5) the fall-back mechanism for the DL signal transmission, (6) the solutions to collisions between the DL signal transmission resource and other signal/channels, and (7) the UE features.

It should be noted that, in the embodiments below, the DL signal transmission may be one or more DL signal transmissions, and the present disclosure is not limited to embodiments below.

### Aspect 1: Indication Information for DL Signal Transmission

In an embodiment, the UE may receive indication information associated with the DL signal transmission. In an embodiment, the indication information comprises at least one of the following information associated with the DL signal transmission:
the availability/unavailability of one or more validity durations or periodicities for the DL signal transmission;
the availability/unavailability of one or more DL signal bursts;
the change of the DL signal transmission;
the configuration of the DL signal transmission;
the value of the validity duration or invalid duration;
the start position of the validity duration;
the gap for ignoring the DL signal transmission;
the periodicity or duration for the DL signal transmission;
the start offset of the validity duration or the periodicity for the DL signal transmission;
the number of the available/unavailable DL signal;
the resource set for the DL signal transmission;
the PO (paging occasion) offset for the DL signal transmission;
the value of SFN (system frame number) or the value of PF (paging frame) index as the reference point of the valid time for the DL signal transmission; wherein the value of the PF index is not larger than the value of the eDRX (Extended Discontinuous Reception) cycle or the default paging cycle (e.g., 10 ms);
the index of a pattern among one or more the DL signal transmission patterns; wherein the patterns include different combinations of the parameters including the validity duration, the periodicity or duration, and/or the start offset of the validity duration or periodicity, or the number of the available DL signal, or the gap, or the reference point;
the de-activation or unavailability of one or more validity durations or periodicities for the DL signal transmission;
no transmission of DL signals;
the stop or unavailability of one or more DL signals;
the HARQ-ACK (hybrid automatic repeat request acknowledgment) feedback for receiving the indication information of the DL signal; and/or
indication of the offset between CD-SSB and NCD-SSB; wherein an offset to transmit CD-SSB and NCD-SSB at different times can be configured via RRC parameters or SIB indication.

### Aspect 2: DL Signals

In an embodiment, the DL signal includes at least one of the following:
the SSB in NR;
the CD (cell-defining)-SSB or NCD (non cell-defining)-SSB;
the SSB with a larger periodicity, e.g., larger than the maximum SSB periodicity in some approaches (e.g., NR Rel-17);
the SSB that is available during a validity duration for a UE;
the small SSB occupying a small number of time and frequency domain resources, e.g., less than the number of time and frequency domain resources occupied by the SSB in some approaches (e.g., NR Rel-17);
the PSS (Primary Synchronization Signal) or the SSS (Secondary Synchronization Signal);
the TRS (Tracking Reference Signal);
the CSI-RS (channel status information reference signal); and/or
the paging signal.

In an embodiment, the DL signal transmission can be used for the synchronization, the AGC (automatic gain control) adjustment or the beam management, or the beam sweeping, or the CSI (channel status information) measurement, the radio link monitoring measurement, or the RRM (Radio Resources Management) measurement, or the BS energy saving, etc.

### Aspect 3: Patterns for the DL Signal Transmission

The patterns for the DL signal transmission are used to determine how the DL signal is transmitted in the time and frequency domains. The patterns include at least one of the following:

### 1) A Valid Time or Invalid Time

In some embodiments, the valid time or invalid time may be determined by at least one of a reference point, an end position, a validity duration, a DRX (discontinuous reception) cycle. In some embodiments, a valid time corresponds to the indication of the availability of the validity duration or the available DL signal and an invalid time corresponds to the indication of the unavailability of the validity duration or the unavailable DL signal.

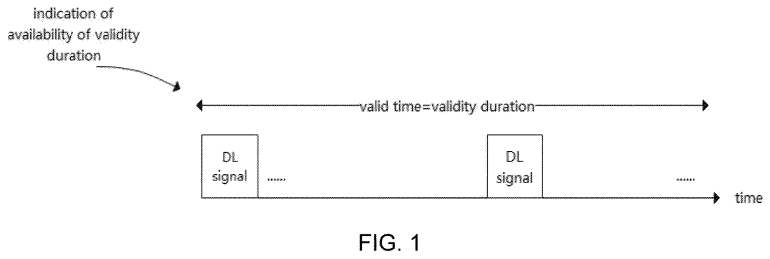

As illustrated in FIG. 1, the indication of the availability of the validity duration indicates a valid time or valid duration that the UE may receive the DL signals therein.

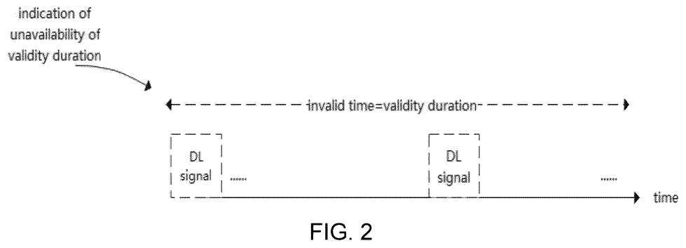

As illustrated in FIG. 2, the indication of the unavailability of the validity duration indicates an invalid time or valid duration that the UE may receive the DL signals therein.

In some embodiments, a reference point may be defined as the start of the valid time or the invalid time. The UE assumes that the DL signal is available or unavailable from the reference point. The reference point is determined by at least one of: a PF offset, a periodicity for the DL signal transmission, an eDRX cycle, a default paging cycle, a DRX cycle, and/or a modification period.

For example, the reference point may be the first PF during the eDRX cycle n or the default paging cycle n.

For example, the reference point may be the start of the DRX cycle or the modification period after the DRX cycle or the modification period where the indication information of the DL signal is received.

For example, the reference point may be configured as a PF n, an SFN n or a slot n.

In some embodiments, the end position of the availability or unavailability of the validity duration or the available or unavailable DL signal is determined by at least one of: a PF offset, a periodicity for the DL signal transmission, an eDRX cycle, a default paging cycle, a DRX cycle and/or a modification period.

For example, the end position may be defined as the first PF, PO, SFN, slot, or symbol after receiving the last available DL signal or an indication of the available DL signal.

For example, the end position may be the start of a gap before a PF or PO that is valid for the UE.

For example, the end position may be the end or start of a periodicity of the DL signal transmission after a PF, SFN, PO, or slot that the indication information of the DL signal is received.

In some embodiments, the duration of the valid time may be equal to a multiple of (e.g., 10 times of) the periodicity or the validity duration for the DL signal transmission, or a number of sequential symbols or slots without slot or symbol configured for uplink intervened.

### 2) A Validity Duration of the DL Signal Transmission

In some embodiments, the value of validity duration is a number of one or more eDRX cycles, or default paging cycles, or DRX cycles.

### 3) A Start Position or the Boundary of the Validity Duration

In some embodiments, the start position or the boundary of the validity duration is determined by at least one of the following:
a position of the (predetermined) first PF during an eDRX cycle or a paging cycle, or a predetermined SFN, e.g., (SFN+PF_offset) mod T=0, wherein T is the value of the eDRX cycle or the paging cycle;
a delay after the reception of the indication; and/or
a gap or a position that receiving the indication information of DL the signal transmission.

In some embodiments, the boundary of the validity duration is determined by a gap or a position that receiving the indication information of the DL signal transmission. In some embodiments, the gap is a duration before the PF, PO, SFN slot, or symbol that receiving the indication information of the DL signal transmission. In some embodiments, the UE assumes that the DL signal is not available during the gap.

### 4) A Periodicity or Duration for the DL Signal Transmission

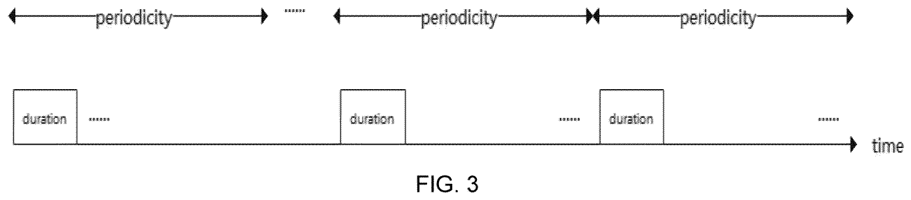

In an embodiment, the UE may assume that the DL signal transmitted during the duration each periodicity is available (see FIG. 3).

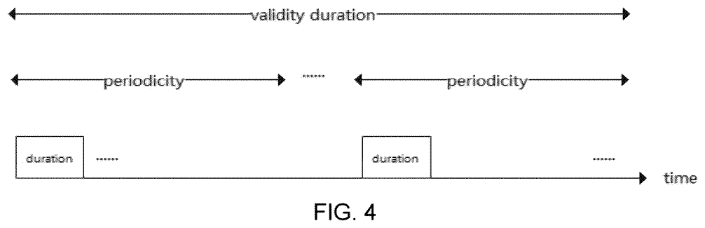

In an embodiment, the DL signal may be available during the duration for a number of periodicities during a validity duration (see FIG. 4).

### 5) Modification Periods for the DL Signal Transmission

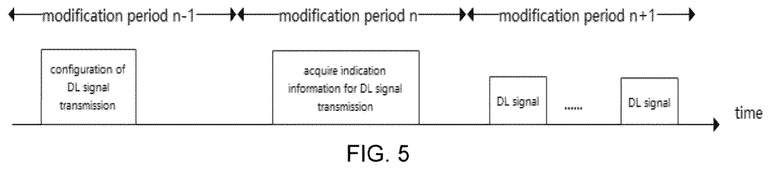

FIG. 5 shows a transmission pattern according to another embodiment of the present disclosure.

In an embodiment, if the UE is configured with a configuration of the DL signal transmission (e.g., period n−1 in FIG. 5), the UE may acquire the indication information of the DL signal transmission during the next modification period (e.g., period n in FIG. 5).

In an embodiment, after the UE receives the indication information of the DL signal transmission during a modification period, the UE may assume that the DL signal transmission during the next modification period (e.g., period n+1 in FIG. 5) is available.

In an embodiment, the two embodiments above can be combined.

In an embodiment, the boundary modification period may be determined by a period value and/or an offset. In an embodiment, the period value may be the period value of the modification period. For example, the boundary of modification period may be determined by an SFN, in which SFN+offset) mod period value=0, and mod indicates a mod function. In some examples, the offset can be zero.

### 6) The DL Signal Transmission Occasion

In an embodiment, the DL signal transmission occasion may be determined by the PO offset.

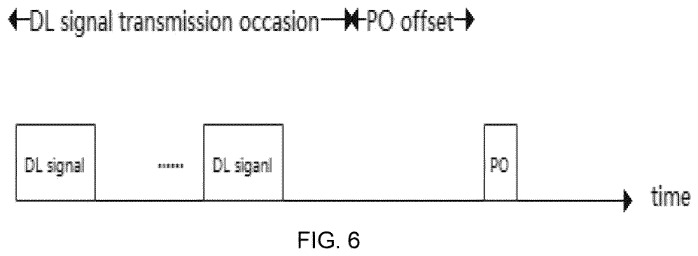

In an embodiment, the DL signal transmission occasion may be available for a number of available DL signals before a PO offset, in which the PO offset is before a PO that is valid for a UE (see FIG. 6).

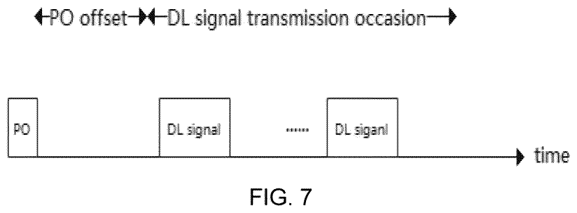

In an embodiment, the DL signal transmission occasion may be available for a number of available DL signals after a PO offset, in which the PO offset is after a PO that is valid for a UE (see FIG. 7).

### 7) Resource Sets for the DL Signal Transmission

In an embodiment, the resource sets for the DL signal transmission may include at least one of the following: a first resource set for a basic pattern, a second resource set for a normal pattern, a third resource set for a pattern configured by the SIB, or a fourth resource set for a UE specific pattern. In an embodiment, the resource sets indicate the time and/or frequency resource sets for the DL signal transmission.

In an embodiment, the first resource set for the basic pattern includes at least one of the following resources: the validity duration, a start position of the validity duration, a number of the available DL signals, the PO offset, and/or a modification period.

In an embodiment, the second resource set for the normal pattern includes at least one of: the resources described above for the first resource set, a periodicity, and/or a duration.

In an embodiment, the third resource set for the pattern configured by the SIB includes at least one of the following resources: the validity duration, a start position of the validity duration, a number of the available DL signals, the PO offset, and/or a modification period.

In an embodiment, the fourth resource set for the UE specific pattern includes at least one of: the resources described above for the first resource set, a periodicity and/or a duration.

In an embodiment, the first resource set or the third resource set is configured for the idle-mode UE; the second resource set or the fourth resource set is configured for the connected-mode UE.

In an embodiment, if the first resource set or the third resource set is ongoing, and a second resource set or a fourth resource set is configured for the UE, the UE may assume that all of the DL signal transmissions in the first or second or third or fourth resource set are available.

### Aspect 4: Indication/Configuration Signaling

In an embodiment, the indication information related to DL signal transmission may include at least one of the following: cell-specific DCI; group-common DCI; UE-specific DCI; MAC CE signaling; RRC signaling; SIB signaling; BS interactions; and/or events.

### Cell-Specific DCI

In an embodiment, the cell-specific DCI may be a DCI carrying the information for all of the UEs in a Cell used to indicate the indication information related to the DL signal transmission. The CRC (cyclic redundancy check) of the cell-specific DCI may be scrambled by P-RNTI, SI-RNTI, TC-RNTI, RA-RNTI.

In an embodiment, the information field of the cell-specific DCI may be designed by at least one of the following:
an information block in the cell-specific DCI configured for the DL signal transmission indication for a cell or a cell group. In an embodiment, the number of block is not larger than the number of cells or cell groups configured by a higher layer parameter. In an embodiment, the number of block is equal to 1. In an embodiment, the starting position of the information block is determined by parameters configured by higher layers for one or more cells or cell groups;
a bitmap field in the cell-specific DCI configured for the DL signal transmission indication for one or more cells or cell groups. In an embodiment, the bit width of the bitmap field is 0 bit if a higher layer parameter associated with DL signal transmission is not configured. Otherwise, the bit width of the bitmap field is an N-bits bitmap (e.g., N is an integer) determined according to the number of cells or the number of groups of cells provided by higher layer parameter. Each bit in the bitmap corresponds to one or more cells or cell groups configured by higher layer parameters; and/or
an indication field in the cell-specific DCI configured for the DL signal transmission indication in a cell.

In an embodiment, the groups of cells may be configured by the BS. The cells supporting the same eDRX parameters or default paging cycle or DRX cycle may be configured in a cell group. The cell can be an SCell (secondary cell), an activated SCell, a dormant SCell, and/or a PCell (primary cell).

In an embodiment, the UE may assume that the SCS (subcarrier spacing) configuration for the transmission or the measurement on the DL signal is the same for a group of cells.

### Group-Common DCI

In an embodiment, the DCI format 2_7 with a CRC scrambled by an RNTI, or the DCI format 1_0 with a CRC scrambled by P-RNTI, or the DCI format 2_6 with a CRC scrambled by PS-RNTI, or the DCI format 2-0, 2-1, 2-2, 2-3, 2-4, or 2-5 may be used to carry the indication information for the DL signal transmission. The field of indication information may be designed as the following:
if an existing DCI format is used to indicate the indication information associated with the DL signal transmission or the higher layer parameters associated with the DL signal transmission is configured for the group of UEs, the existing information field(s) or a new information field is used to indicate information associated with the DL signal transmission. The existing fields may include at least one of:
a. the ‘Slot format indicator’ or Available RB set Indicator or COT duration indicator or Search space set group switching flag in DCI format 2_0 with a CRC scrambled by SFI-RNTI;
b. the pre-emption indication in DCI format 2_1 with a CRC scrambled by INT-RNTI;
c. the fields in DCI format 2_2 with a CRC scrambled by TPC-PUSCH-RNTI or TPC-PUCCH-RNTI or DCI format 2_3 with a CRC scrambled by TPC-SRS-RNTI, or DCI format 2_4 with CRC scrambled by CI-RNTI, or DCI format 2_5 with a CRC scrambled by AI-RNTI;
d. the fields of ‘Wake-up indication’ or ‘SCell dormancy indication’ in a block in DCI format 2_6 with a CRC scrambled by PS-RNTI; and/or
e. a paging indication field or a TRS (tracking reference signal) availability indication in DCI format 2_7 with a CRC scrambled by PEI-RNTI.
the UE group may be determined based on at least one of the following:
a. the UE identity of the UE in a group being configured by higher layer parameters;
b. a number of groups of UE being configured by higher layer parameters; and/or
c. the UEs with the valid POs in a same PF or in a number of sequential PFs during an eDRX cycle or a default paging cycle being configured as a same UE group.
the information field in the group-common_DCI may indicate one or more UEs according to the following:
a. one information block in the group-common DCI is configured for a UE in the UE group;
b. One information block in the group-common DCI is configured for a group of UEs; and/or
c. a bit in a bitmap in the group-common DCI is configured for one or more groups of UEs.

### UE-Specific DCI

In an embodiment, the DCI format 0-1 or DCI format 0-2, or DCI format 1-1 or DCI format 1-2 or a new DCI may be used to carry the indication information for the DL signal transmission.

In an embodiment, one indication field in the UE-specific DCI is configured for the DL signal transmission indication for the UE. In an embodiment, the indication field is a bitmap to indicate the availability of one or more validity durations or periodicities for the DL signal transmission. In an embodiment, the indication field is a n-bits field to indicate the reference point or start SFN/slot/symbol for the validity duration or the available DL signal transmission.

In an embodiment, one or more existing information fields are used to indicate the indication information related to the DL signal transmission. The existing information fields include:
the field of ‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_0 with a CRC scrambled by C-RNTI or CS-RNTI or MCS-C-RNTI;
‘HARQ-ACK bitmap’ or ‘All the remaining bits’ used for indicating CG-DFI, ‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_1 with a CRC scrambled by C-RNTI or CS-RNTI or SP-CSI-RNTI or MCS-C-RNTI;
‘Frequency domain resource assignment’, ‘Time domain resource assignment’, ‘Modulation and coding scheme’, ‘New data indicator’, ‘Redundancy version’, ‘HARQ process number’, or ‘UL/SUL indicator’ in DCI format 0_2 with a CRC scrambled by C-RNTI or CS-RNTI or SP-CSI-RNTI or MCS-C-RNTI;
‘Random Access Preamble index’, ‘UL/SUL indicator’, ‘SS/PBCH index’, ‘PRACH Mask index’, ‘Reserved bits’, ‘Time domain resource assignment’, ‘Modulation and coding scheme’, ‘New data indicator’, ‘Redundancy version’, ‘HARQ process number’, ‘Downlink assignment index’, ‘PUCCH resource indicator’, ‘Short Messages’ or ‘TRS availability indication’ in DCI format 1_0 with a CRC scrambled by C-RNTI or CS-RNTI or MCS-C-RNTI; and/or
‘Frequency domain resource assignment’, ‘Time domain resource assignment’, ‘Modulation and coding scheme’ for transport block 1, ‘New data indicator’ for transport block 1, ‘Redundancy version’ for transport block 1, ‘HARQ process number’, ‘PDSCH group index’, or ‘HARQ-ACK retransmission indicator’, or ‘SCell dormancy indication’ in DCI format 1_1 or DCI format 1_2 with a CRC scrambled by C-RNTI or CS-RNTI or MCS-C-RNTI.

### MAC CE Signaling

In an embodiment, MAC CE signaling is used to indicate the indication information.

For example, information including the activation and/or start of the DL signal transmission or the deactivation and/or stop of the DL signal transmission or the change of the DL signal transmission.

### RRC Signaling

In an embodiment, the parameters for the DL signal transmission include at least one of the following:

the indication information for the DL signal transmission mentioned above;

the parameters of the DL signal transmission configured for a cell or a group of cells; and/or
the parameters of the DL signal transmission configured for a UE or a group of UEs.

### SIB Signaling

In an embodiment, if the UE is configured to support the DL signal transmission, the UE may acquire the SIB information during the valid modification period.

In an embodiment, the UE assumes that the modification period for the SIB acquisition is the modification period n after the modification period n−1 that the indication of SI change was received or is the modification period according to the mechanisms in a legacy approach.

In an embodiment, the DL signal transmission during the modification period n+1 is available for the UE if the information carried by the SIB indicates the start or available of the DL signal transmission. If the SIB acquired by the UE does not carry the indication information for the DL signal transmission, the UE assumes that the DL signal transmission is stopped or is not started or is unavailable. If the SIB is not acquired by the UE during the modification period n+1, the UE assumes that the DL signal transmission is stopped or is not started or is unavailable.

In an embodiment, the indication information carried by the SIB includes at least one of the following:
the index of the DL signal;
the availability of one or more validity durations of the DL signal transmission;
the availability of one or more DL signals;
the parameters associated with the DL signal transmission occasions;
the number of the RBs or the OFDM symbols occupied by the DL signal;
the periodicity or duration for the DL signal transmission;
the start offset for validity duration or periodicity for the DL signal transmission;
the start position or reference point for the validity duration or for the available DL signal;
whether the DL signal transmission is configured/started/stopped or not;
whether the DL signal transmission is valid or not; and/or
whether the other signal transmission is deactivated or not.

### BS Interaction

In an embodiment, if the UE is configured with supporting the DL signal transmission, the information associated with the DL signal transmission is interacted among the BS and other peer BSs or neighbor BSs. The interaction information includes at least one of the following:
whether the DL signal transmission is supported by a Serving Cell or not can be interacted among the wireless communication nodes through the Xn interface;

whether the DL signal transmission is supported by a group of UE or not can be interacted among the wireless communication nodes through the Xn interface; and/or
the Xn interface supports the exchange of signalling information between two NG-RAN nodes, and the forwarding of PDUs to the respective tunnel endpoints.

### Events

In an embodiment, if the UE is configured with the DL signal transmission, the DL signal transmission is triggered by at least one of an event on the BS side, an event on the UE side, and/or a timer.

In an embodiment, the event on the BS side may include at least one of:
the BS receives request for the DL signal transmission sent by the UE;
the BS receives the acknowledgement information for the DL signal transmission configuration by a number of UEs, wherein the number of UEs is not smaller than 1, or is larger than a threshold; the threshold is equal to a multiple of the number of idle-mode UEs or connected-mode UEs in a cell; wherein the multiple is a fraction and is larger than 0;
a Serving Cell is configured with the DTX;
the value of RSRP/RSRQ reported by one or more UEs is lower than a threshold;
the load percent is smaller than a threshold; and/or
the DL or UL data volume is smaller than a threshold.

In an embodiment, the event on the UE side may include at least one of:
the UE reports the acknowledgement for the DL signal transmission configuration;
the UE's DL signal transmission is restricted on a serving cell;
the UE does not need to perform PDCCH monitoring for a duration;
measurement results based on the SSB or CSI-RS or TRS or PTRS or PRS resource are smaller than a threshold;
measurement results of RSRP/RSRQ are smaller than a threshold;
the associated SSB and CSI-RS resource configured by higher layer parameters are quasi co-located for a UE; and/or
RRC configurations or reconfigurations including indication information associated with the DL signal transmission include at least one of the following:
the indication information for the DL signal transmission mentioned above;
the modification period; and/or
the Serving Cell ID or Serving Cell group ID for supporting the DL signal transmission.

In an embodiment, the timer is used for the DL signal transmission. When the timer is expired, the DL signal transmission is stopped or started.

In an embodiment, an offset to transmit CD-SSB and NCD-SSB at different times can be configured via RRC parameters or SIB indication. The indication for the offset between CD-SSB and NCD-SSB is 3 bits. The values for the 3 bits are defined according to at least one of the following four methods:
1. the values for the 3 bits includes at least one of the {sf30, sf40, sf60, sf80, sf120}, besides {sf5, sf10, sf15};
For example, {sf5, sf10, sf15, sf30, sf40, sf60, sf80, sf120}, or
{sf5, sf10, sf15, sf30, sf40, sf60, sf80, spare1}, or
{sf5, sf10, sf15, sf30, sf60, sf80, spare2, spare1}, or
{sf5, sf10, sf15, sf30, sf60, spare3, spare2, spare1}, or
{sf5, sf10, sf15, sf30, sf60, sf80, spare2, spare1}, or
{sf5, sf10, sf15, sf30, sf60, sf120, spare2, spare1}, in this case, the offset can be described as 5*2\hat{ }n, where n=0, 1, 2, 3, 4, 5.

Where Value sf5 means the first burst of Non-Cell Defining SSB is transmitted 5 ms later than the first burst of CD-SSB transmitted after the first symbol of SFN=0 of the serving cell, value sf10 means the first burst of Non-Cell Defining SSB is transmitted 10 ms later than the first burst of CD-SSB transmitted after the first symbol in SFN=0 of the serving cell, and so on.
2. the values for the 3 bits includes at least one of the {¼, ½, ¾}, besides {sf5, sf10, sf15};

For one example, {sf5, sf10, sf15, ¼, ½, ¾, spare2, spare1}. For another example, {sf5, sf10, sf15, ½, ¾, spare3, spare2, spare1}. Wherein Value sf5 means the first burst of Non-Cell Defining SSB is transmitted 5 ms later than the first burst of CD-SSB transmitted after the first symbol of SFN=0 of the serving cell. Wherein value ¼ means the first burst of Non-Cell Defining SSB is transmitted ¼*T ms later than the first burst of CD-SSB transmitted after the first symbol of SFN=0 of the serving cell, and T is the periodicity of CD-SSB, e.g., defined by ssb-periodicityServingCell.
3. the offset values for the 3 bits is defined on the position based on {¼, ½, ¾}*T. T={ms5, ms10, ms20, ms40, ms80, ms160}, is the periodicity of CD-SSB, e.g., defined by ssb-periodicityServingCell;
4. the offset values are less or equal than the periodicity of SSB, or some of the values are less than the periodicity of SSB.

For example, when the SSB periodicity is 5 ms, the offset should be one of 0 or 5 ms.

For example, when the SSB periodicity is 10 ms, the offset should be one of 0 or 5 or 10 ms.

For example, when the SSB periodicity is 80 ms, the offset should be one of 0 or 5 or 10 or {¼, ½, ¾} *T ms.

### Aspect 5: The Fall-Back Mechanism for DL Signal Transmission

In an embodiment, if a UE is provided by the configuration of the DL signal transmission and the UE does not receive the indication information associated with the DL signal transmission in the predefined resource, the UE may assume that: the DL signal transmission is not available during a specific resource; the DL signal transmission is available during a specific resource; or whether the DL signal transmission is available or not during a specific resource is determined by the higher layer parameter configuration. In an embodiment, the higher layer parameter configuration can indicate the availability of the DL signal transmission is true or false.

In an embodiment, the DL signal transmission being not available during a specific resource described above may include at least one of:
the DL signal transmission during the validity duration or periodicity after the predefined resource is not available;
the DL signal transmission during the validity duration or periodicity after the predefined PDCCH monitoring occasions is not available; and/or
the DL signal transmission during the modification period after the modification period for acquiring the SIB is not available.

In an embodiment, the DL signal transmission being available during a specific resource described above may include at least one of:
the DL signal transmission from the DL signal transmission configuration until the start of the gap before the time of a new indication information associated with the DL signal transmission is available;
the DL signal transmission from the DL signal transmission configuration until the start of a next indication information associated with the DL signal transmission is available;
the DL signal transmission during the first one validity duration or periodicity after the predefined resource for detecting indication information for the DL signal transmission is available;
the DL signal transmission during a valid time after predefined resource for detecting indication information for the DL signal transmission is available; the valid time is configured by higher layer parameters; and/or
the DL signal transmission during the first one modification period after the modification period for acquiring the SIB which indicates information for the DL signal transmission is available.

In an embodiment, if a UE is provided by the configuration of the DL signal transmission and the UE does not acquire the SIB indicating information associated with the DL signal transmission in the modification period, the UE may assume that:
keeping acquiring the SIB information during the next sequential modification period; or
assuming the DL signal transmission is available during a specific resource; or
stopping acquiring the SIB information and assuming the DL signal transmission is not available.

In an embodiment, if a UE is configured with change of the DL signal transmission and the UE does not receive the information associated with the DL signal transmission from the acquired SIB during the modification period after the modification period that the SI change or the DL signal transmission configuration is received, the UE may assume that:
keeping acquiring the SIB information during the next sequential modification period; or
stopping acquiring the SIB information and assuming the DL signal transmission is not available.

In an embodiment, if a DL signal transmission is ongoing, and the UE is indicated by a change of the DL signal transmission, if the UE does not receive the indication information associated with the change of the DL signal transmission, the UE may assume that the original signal transmission is not changed.

In an embodiment, if a UE is configured with the DL signal transmission and the UE does not receive any DL signal during the valid time for the DL signal transmission, the UE may assume that:
the PDCCH or PDSCH reception associated with the transmission or measurement of the DL signal may use the last recent transmission or measurement of the DL signal; or
the original DL signal transmission is available;
or the transmission or measurement on the DL signal is selected for UE requirement; or
the DL signal transmission falls back to a default pattern of the DL signal transmission, or the default configuration for the DL signal transmission; wherein the default pattern or default configuration for the DL signal transmission is the pattern or configuration for the last recent DL signal transmission or indicated by RRC signaling; or
the DL signal transmission during one or more additional validity durations or periodicities or modification periods is available.

### Aspect 6: Collisions Between the DL Signal Transmission Resource and Other Signal/Channels

In an embodiment, if the transmission occasion of the DL signal overlaps with another channel/signal transmission or reception in time, the UE receives the DL signal/channel with the higher priority.

In an embodiment, the priority is determined by an indication from the gNB.

### Aspect 7: UE Features

In an embodiment, the UE features includes at least one of: the support of the DL signal transmission; the support of the request or feedback for the DL signal transmission configuration; and/or the support of the SCell without SSB for inter-band carrier aggregation (CA).

In the cases of empty and low resource utilization, common signal transmission, e.g., SSB or SIB, occupies a large portion on time domain. According to system-level simulation, if the SSB or SIB transmission can be limited or eliminated on the SCell, the BS can obtain amount of energy saving benefits. For intra-band CA, a UE feature of support of the SCell without SS/PBCH block is defined. For inter-band CA, a UE feature of support of the SCell without SS/PBCH block can be also defined. Namely, for inter-band CA, whether or not a UE is able to use SS/PBCH block from other cells for time/frequency synchronization of the SCell without SS/PBCH block can be indicated by the UE feature. The UE feature of support of CSI-RS RRM measurement for the SCell without SS/PBCH block can be used for time/frequency synchronization of the SCell. Namely, the UE may perform measurements based on CSI-RS resource and may base the timing of the CSI-RS resource on the timing of the serving cell.

In the paragraphs below, some operating examples of the present disclosure are provided, but the present disclosure is not limited thereto.

### Method 1: Indication of the Available DL Signal Transmission

In an embodiment, the DL signal transmission may be SSB transmission. The available SSB is indicated according to at least one of the following: a validity duration, a number of available SSB, an SIB indication, a DCI indication, a high layer parameter, and/or a fall back mechanism.

### Validity Duration

In an embodiment, the UE assumes that the SSB transmitted during a validity duration is available. If the parameter of available SSB is provided, the SSB transmitted during a duration (e.g., the validity duration) from a first position to the start of a frame (e.g., a second position) which is available for paging reception for a UE.

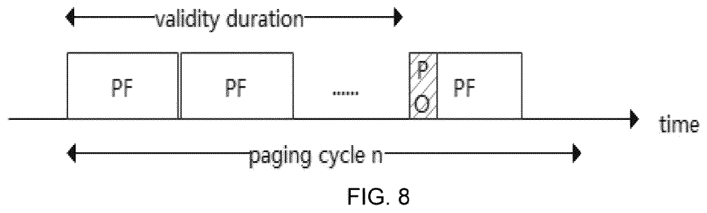

In an embodiment, as illustrated in FIG. 8, the first position is the start of a first paging frames associated with a number of PDCCH monitoring occasions for DCI format 2_7; wherein the start of the frame (e.g., the second position) is the frame associated with the PO where the paging information is received. The validity duration is between the first position to the start of the frame (e.g., the second position) associated with the PO.

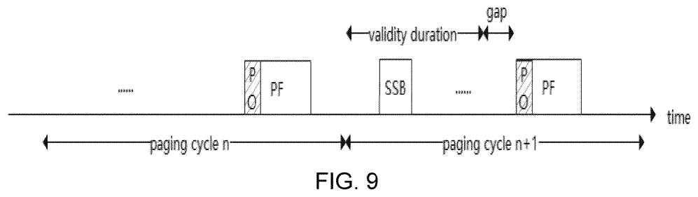

In an embodiment, as illustrated in FIG. 9, the first position is the start of the paging cycle (e.g., paging cycle n+1) right next to the last recent PO that paging is received (e.g., paging cycle n); wherein the start of the frame (e.g., the second position) is the frame before the start of a gap; wherein the gap is a duration before the start of the first valid PF or valid PO for the UE during the paging cycle. The validity duration is between the first position to the start of the frame (e.g., the second position) before the start of the gap.

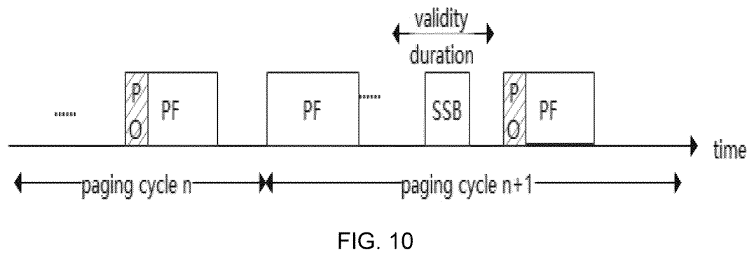

In an embodiment, as illustrated in FIG. 10, the first position is the start of the validity duration during the paging cycle n+1 next to the paging cycle n or n−1 associated with the last recent PO that paging is received. The start of validity duration is indicated by the DCI format 1_0 with CRC scrambled by P-RNTI or DCI format 2_7 with a CRC scrambled by a RNTI. In an embodiment, the start of validity duration is the start of PF n during the paging cycle n+1 and PF n means the n-th PF during the paging cycle n+1.

In an embodiment, the validity duration for available SSB is associated with the start of PF associated with the paging cycle or the position of PO associated with the UE. The validity duration is the multiple of paging cycle or the multiple of PF and the value of the multiple is less than 1 (e.g., 1/32, 1/16, 1/10, ⅛, ¼ or ½) or a positive number that is larger than 1; or the validity duration is a number of slots which is not larger than 2.

In an embodiment, a gap is used as a duration from the end of validity duration to the start of the first valid PF or valid PO for the UE during the paging cycle n+1, or a duration before the start of the first valid PF or valid PO for the UE during the paging cycle n+1; wherein the UE assumes the DL signal transmission is restricted during the gap, or wherein measurement based on the DL signal is restricted during the gap. The gap is a number of symbols which is configured by higher layers.

In an embodiment, the start position of the paging cycle or the PF or the PO are determined by the higher layer parameters.

### Number of Available SSB

In an embodiment, the number of available SSBs is indicated by DCI or higher layer parameters. The UE assumes that the number of available SSBs transmitted before the first position (e.g., the start of the validity duration). After the number of received SSBs in the validity duration reaches the number of available SSBs, the new received SSB(s) is not available.

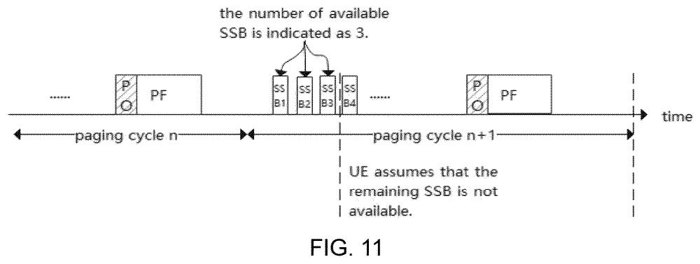

In an embodiment, as illustrated in FIG. 11, the first position is the first valid PF of the paging cycle (e.g., paging cycle n+1) after the paging cycle that the indication DCI is received (e.g., paging cycle n).

In an embodiment, the number of available SSBs is not larger than the maximum number of SSBs configured for the cell or UE.

In an embodiment, the reference point of the first available SSB is the SSB transmitted after the DCI format 2_7 with a CRC scrambled by a RNTI or the DCI format 1_0 with scrambled by P-RNTI carrying the indication of the available SSBs.

In an embodiment, the number of SSBs measured by the UE is less than the number of available SSBs, the UE may assume that the SSB transmitted during the gap is available.

### SIB Indication

In an embodiment, the validity duration or the number of available SSBs can be indicated by a SIB. UE assumes that the SSBs transmitted during the validity duration is available or the number of available SSBs transmitted during the validity duration is available for paging reception.

### Fall Back Mechanism

In an embodiment, after the paging cycle associated with the end of the validity duration, the UE assumes that the SSB transmission according to the higher layer configuration before the indication of the validity duration or the number of available SSBs is available.

### Method 2: Indication of the DL Signal Transmission Deactivation and the DL Signal Transmission Activation

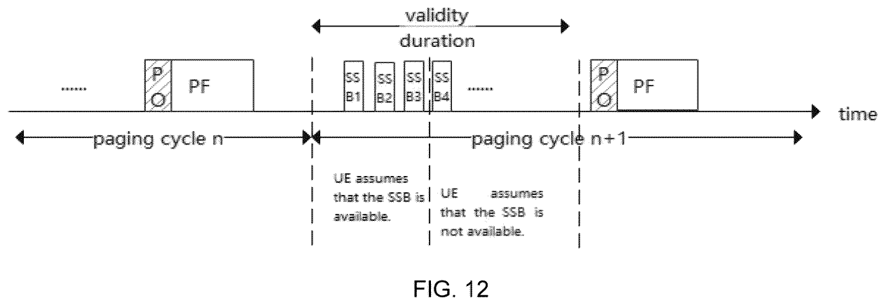

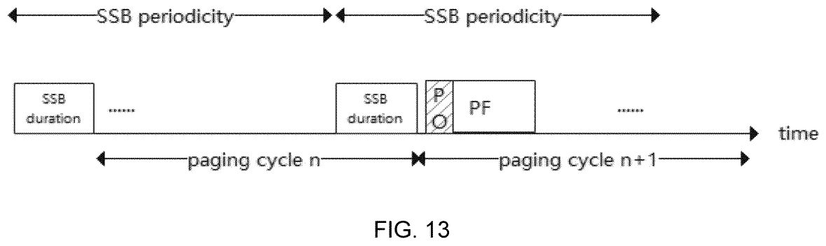

FIGS. 12 and 13 show different set of patterns according to an embodiment of the present disclosure.

In an embodiment, if a configuration of the DL signal transmission in a first approach is provided, the DL signal transmission in a second approach may deactivated or ignored.

In an embodiment, the DL signal transmission in the first approach has multiple patterns of the DL signal transmission. The multiple patterns of the DL signal transmission include at least one of the following:
the first set of patterns determined by parameters includes at least one of: the validity duration of the DL signal transmission; the number of available DL signal; the gap; the reference point of the start of validity duration; and/or the reference point of the first available DL signal transmission;
the second set of patterns determined by parameters includes at least one of: the periodicity of the DL signal transmission; the duration for the DL signal transmission; the number of the DL signal bursts during the duration; and/or the gap; wherein the periodicity of the DL signal transmission is larger than 160 ms; and/or
the third set of patterns determined by parameters includes at least one of: the periodicity of the DL signal transmission; the duration for the DL signal transmission; the number of the DL signal burst during the duration; and/or the validity duration; wherein the duration or periodicity during the validity duration is valid for the DL signal transmission.

In an embodiment, the time or frequency domain resource occupied by the DL signal in the first approach is less than that occupied by the DL signal the second approach.

In an embodiment, an SIB can configure one of the multiple patterns for the UE or cell.

In an embodiment, if the configuration of the DL signal transmission in the first approach is provided, the DL signal transmission in the second approach is also valid.

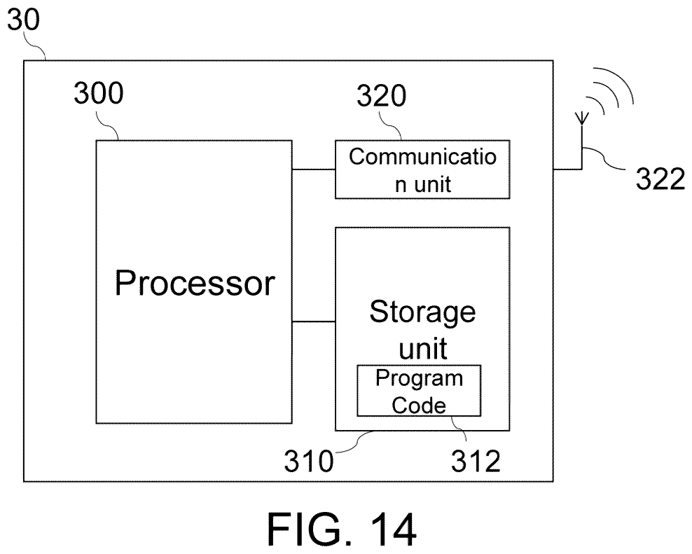

FIG. 14 relates to a diagram of a wireless communication terminal 30 according to an embodiment of the present disclosure. The wireless communication terminal 30 may be a tag, a mobile phone, a laptop, a tablet computer, an electronic book or a portable computer system and is not limited herein. The wireless communication terminal 30 may include a processor 300 such as a microprocessor or Application Specific Integrated Circuit (ASIC), a storage unit 310 and a communication unit 320. The storage unit 310 may be any data storage device that stores a program code 312, which is accessed and executed by the processor 300. Embodiments of the storage code 312 include but are not limited to a subscriber identity module (SIM), read-only memory (ROM), flash memory, random-access memory (RAM), hard-disk, and optical data storage device. The communication unit 320 may a transceiver and is used to transmit and receive signals (e.g., messages or packets) according to processing results of the processor 300. In an embodiment, the communication unit 320 transmits and receives the signals via at least one antenna 322.

In an embodiment, the storage unit 310 and the program code 312 may be omitted and the processor 300 may include a storage unit with stored program code.

The processor 300 may implement any one of the steps in exemplified embodiments on the wireless communication terminal 30, e.g., by executing the program code 312.

The communication unit 320 may be a transceiver. The communication unit 320 may as an alternative or in addition be combining a transmitting unit and a receiving unit configured to transmit and to receive, respectively, signals to and from a wireless communication node.

In some embodiments, the wireless communication terminal 30 may be used to perform the operations of the UE described above. In some embodiments, the processor 300 and the communication unit 320 collaboratively perform the operations described above. For example, the processor 300 performs operations and transmit or receive signals, message, and/or information through the communication unit 320.

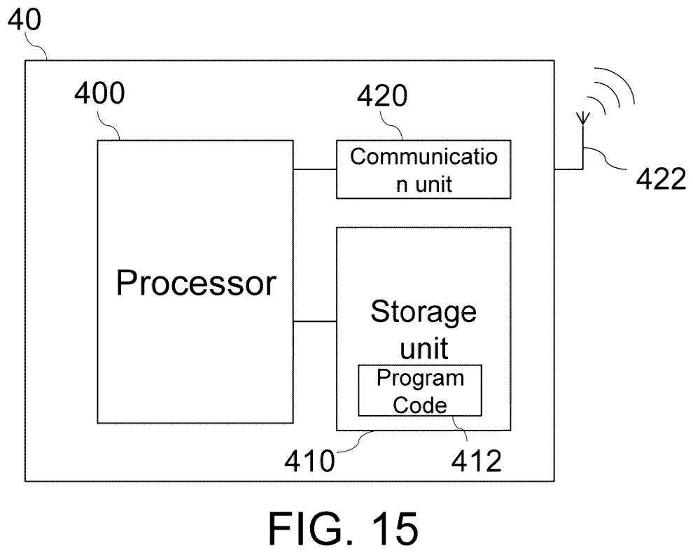

FIG. 15 relates to a diagram of a wireless communication node 40 (e.g., a session management node) according to an embodiment of the present disclosure. The wireless communication node 40 may be a satellite, a base station (BS), a gNB, a network entity, a Domain Name System (DNS) server, a Mobility Management Entity (MME), Serving Gateway (S-GW), Packet Data Network (PDN) Gateway (P-GW), a radio access network (RAN), a next generation RAN (NG-RAN), a data network, a core network, a communication node in the core network, or a Radio Network Controller (RNC), and is not limited herein. In addition, the wireless communication node 40 may include (perform) at least one network function such as an access and mobility management function (AMF), a session management function (SMF), a user place function (UPF), a policy control function (PCF), an application function (AF), etc. The wireless communication node 40 may include a processor 400 such as a microprocessor or ASIC, a storage unit 410 and a communication unit 420. The storage unit 410 may be any data storage device that stores a program code 412, which is accessed and executed by the processor 400. Examples of the storage unit 412 include but are not limited to a SIM, ROM, flash memory, RAM, hard-disk, and optical data storage device. The communication unit 420 may be a transceiver and is used to transmit and receive signals (e.g., messages or packets) according to processing results of the processor 400. In an example, the communication unit 420 transmits and receives the signals via at least one antenna 422.

In an embodiment, the storage unit 410 and the program code 412 may be omitted. The processor 400 may include a storage unit with stored program code.

The processor 400 may implement any steps described in exemplified embodiments on the wireless communication node 40, e.g., via executing the program code 412.

The communication unit 420 may be a transceiver. The communication unit 420 may as an alternative or in addition be combining a transmitting unit and a receiving unit configured to transmit and to receive, respectively, signals, messages, or information to and from a wireless communication node or a wireless communication terminal.

In some embodiments, the wireless communication node 40 may be used to perform the operations of the BS or gNB described above. In some embodiments, the processor 400 and the communication unit 420 collaboratively perform the operations described above. For example, the processor 400 performs operations and transmit or receive signals through the communication unit 420.

In accordance with one embodiment of the present disclosure, a wireless communication method includes: receiving, by a wireless communication terminal (e.g., the UE described above) from a wireless communication node (e.g., the gNB or BS described above), indication information (e.g., the indication information described above) of one or more downlink, DL, signal transmissions (e.g., the DL signal transmission(s) described above), wherein the indication information indicates one or more transmission patterns (e.g., the pattern(s) described above) for the one or more DL signal transmissions; and receiving, by the wireless communication terminal from the wireless communication node, one or more DL signals (e.g., the DL signal(s) described above) according to the one or more patterns for the one or more DL signal transmissions.

In accordance with another embodiment of the present disclosure, a wireless communication method includes: transmitting, by a wireless communication node to a wireless communication terminal, indication information of one or more downlink, DL, signal transmissions, wherein the indication information indicates one or more transmission patterns for the one or more DL signal transmissions; and transmitting, by the wireless communication node to the wireless communication terminal, one or more DL signals according to the one or more patterns for the one or more DL signal transmissions.

Details of the wireless communication methods can be ascertained by referring to the embodiments described above, and will not be repeated herein.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand example features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described example embodiments.

It is also understood that any reference to an element herein using a designation such as “first,” “second,” and so forth does not generally limit the quantity or order of those elements.

Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A wireless communication method comprising:
receiving, by a wireless communication terminal from a wireless communication node, indication information of one or more downlink (DL) signal transmissions, wherein the indication information indicates one or more transmission patterns for the one or more DL signal transmissions; and
receiving, by the wireless communication terminal from the wireless communication node, one or more DL signals according to the one or more patterns for the one or more DL signal transmissions.

2. The wireless communication method of claim 1, wherein the indication information comprises at least one of:
an indication of an availability or unavailability of one or more validity durations for the one or more DL signal transmissions;
an indication of an availability or unavailability of one or more DL signal bursts;
a change of the one or more DL signal transmissions;
a configuration of the one or more DL signal transmissions;
a value of a validity duration or an invalid duration;
a start position of the validity duration;
a gap for ignoring the one or more DL signal transmissions;
a periodicity or duration for the one or more DL signal transmissions;
a start offset of the validity duration or a periodicity for the one or more DL signal transmissions;
a number of available or unavailable DL signals;
a resource set for the one or more DL signal transmissions;
a paging occasion (PO) offset for the one or more DL signal transmissions;
a value of a system frame number (SFN) or a value of a paging frame, PF, index as a reference point of a valid time for the one or more DL signal transmissions;
an index of a pattern among the one or more patterns for the one or more DL signal transmissions;
a de-activation or unavailability of one or more validity durations or periodicities for the one or more DL signal transmissions;
an indication of no transmission of the one or more DL signals;
a stop or unavailability of at least one of the one or more DL signals; or
a hybrid automatic repeat request acknowledgment (HARQ-ACK) feedback for receiving the indication information;
wherein the value of PF index is not larger than a value of an Extended Discontinuous Reception (eDRX) cycle or a default paging cycle over 10 milliseconds;
wherein the one or more DL signals comprises at least one of:
a Synchronization Signal Block (SSB);
a cell defining (CD) SSB or non cell-defining (NCD) SSB;
an SSB being available during a validity duration for the wireless communication terminal;
a Primary Synchronization Signal, PSS, or Secondary Synchronization Signal (SSS);
a Tracking Reference Signal (TRS);
a channel status information reference signal (CSI-RS); or
a paging signal;
wherein the one or more DL signals are used for at least one of: a synchronization, an automatic gain control (AGC) adjustment, a beam management, a beam sweeping, a channel status information (CSI) measurement, a radio link monitoring measurement, a Radio Resources Management (RRM) measurement, or an energy saving for the wireless communication node.

3. The wireless communication method of claim 1, wherein the one or more transmission patterns comprises at least one of:
a valid time or invalid time;
a validity duration;
a start position or a boundary of the validity duration;
a modification period for the one or more DL signal transmissions;
a DL signal transmission occasion; or
a resource set;
wherein the valid time or invalid time is determined based on at least one of: a start point, an end position, a duration of the valid time or invalid time, a Discontinuous Reception (DRX) cycle, an indication of an availability of a validity duration or available DL signals, or an indication of an unavailability of a validity duration or unavailable DL signals;
wherein at least one of the start point or the end position is determined based on at least one of a PF offset, a periodicity for the one or more DL signal transmissions, an eDRX cycle, a default paging cycle, a DRX cycle, or a modification period;
wherein the duration of the valid time or invalid time is determined based on at least one of: a multiple of a periodicity or a validity duration for the one or more DL signal transmissions, or a certain number of sequential symbols or slots;
wherein the validity duration is a number of eDRX cycles, default paging cycles, or DRX cycles;
wherein a start position of the validity duration is determined based on at least one of: a position of a first PF during an eDRX cycle or a paging cycle, a predetermined system frame number, SFN, or a delay after a reception of the indication information;
wherein a boundary of the validity duration is determined based on at least one of: a gap or a position that receiving the indication information of the one or more DL signal transmissions;
wherein the gap is a period before a PF, PO, SFN, slot, or symbol that the wireless communication terminal receives the indication information of the one or more DL signal transmissions, and the wireless communication terminal is not allowed to receive the one or more DL signals in the gap.

4. The wireless communication method of claim 3, wherein the wireless communication terminal receives a configuration of the one or more DL signal transmissions in a first modification period, receives the indication information in a second modification period adjacent to the first modification period, and receives the one or more DL signals in a third modification period adjacent to the second modification period;
wherein a boundary of the modification periods is determined based on at least one of a period value or an offset;
wherein a boundary of the DL signal transmission occasion is determined based on a PO offset.

5. The wireless communication method of claim 3, wherein the resource set comprises at least one of: a first resource set for a basic pattern, a second resource set for a normal pattern, a third resource set for a pattern configured by a system information block (SIB) or a fourth resource set for a user equipment (UE) specific pattern;
wherein at least one of the first or third resource set is determined based on at least one of: a validity duration, a start position of validity duration, a number of available DL signals, a PO offset, or a modification period;
wherein at least one of the first or third resource set is configured for a UE in an idle-mode;
wherein at least one of the second or fourth resource set is determined based on at least one of: a validity duration, a start position of validity duration, a number of available DL signals, a PO offset, a modification period, a DRX cycle, a periodicity, or a duration;
wherein at least one of the second or fourth resource set is configured for a UE in a connected-mode.

6. The wireless communication method of claim 1, wherein the indication information is indicated by at least one of: Cell-specific DCI, Group-common DCI, UE-specific DCI, a Medium Access Control Control Element (MAC CE), Radio Resource Control (RRC), signaling, or an SIB;
wherein the Cell-specific DCI comprises at least one of: an information block comprising an indication for the one or more DL signal transmissions for all UEs in one or more cells or one or more cell groups, a bitmap field comprising one or more indications for the one or more DL signal transmissions for all UEs in one or more cells or one or more cell groups, or an indication field comprising an indication for the one or more DL signal transmissions for all UEs in a cell or a cell group;
wherein the one or more cell groups supports at least one of: same eDRX parameters, a same default paging cycle, or a same DRX cycle;
wherein the Group-common DCI comprises at least one of: an information block configured for a UE in a group of UEs; an information block configured for a group of UEs; or a bitmap, wherein each bit is configured for one or more groups of UEs;
wherein the group of UEs supports at least one of: having valid POs in a same PF, or having valid POs in a number of sequential PF during an eDRX cycle or a default paging cycle.

7. The wireless communication method of claim 6, wherein the Group-common DCI indicates the indication information in at least one field of: a slot format indicator, an available resource block (RB) set indicator, or a channel occupancy time (COT) duration indicator, a search space set group switching flag, a pre-emption indication, a wake-up indication, a secondary cell, SCell, dormancy indication, a paging indication, or a TRS availability indication;
wherein the UE-specific DCI comprises at least one of: a bitmap to indicate an availability of one or more validity durations or periodicities for the one or more DL signal transmissions, or an indication field indicating at least one of: a reference point, a start SFN, a slot, a symbol for a validity duration or the DL signal transmission;
wherein the UE-specific DCI indicates the indication information in at least one field of: a frequency domain resource assignment, a time domain resource assignment, a modulation and coding scheme, a new data indicator, a redundancy version, an HARQ process number, an uplink or supplementary uplink (UL/SUL) indicator, an HARQ-ACK bitmap, an indicator of all remaining bits used for configured grant downlink feedback information (CG-DFI), a redundancy version, a random access preamble index, a synchronization signal/physical broadcast channel (SS/PBCH) index, a physical random access channel (PRACH) mask index, reserved bits, a downlink assignment index, a physical uplink control channel (PUCCH) resource indicator, a field of short messages, a TRS availability indication, a physical downlink shared channel (PDSCH) group index, an HARQ-ACK retransmission indicator, or an SCell dormancy indication;
wherein the RRC signaling comprises at least one of: parameters of the one or more DL signal transmissions configured for a cell or a group of cells, or parameters of the one or more DL signal transmissions configured for a UE or a group of UEs;
wherein the SIB comprises at least one of:
an index of one of the one or more DL signals;
an availability of one or more validity durations of the one or more DL signal transmissions;
an availability of at least one of the one or more DL signals;
parameters associated with DL signal transmission occasions;
a number of RBs or orthogonal frequency-division multiplexing (OFDM) symbols occupied by the one or more DL signals;
a periodicity or duration for the one or more DL signal transmissions;
a start offset for a validity duration or a periodicity for the one or more DL signal transmissions;
a start position or reference point for a validity duration or for the one or more DL signals;
an indication indicating whether the one or more DL signal transmissions are configured, started, or stopped;
an indication indicating whether the one or more DL signal transmissions are valid; or
an indication indicating whether another signal transmission is deactivated.

8. The wireless communication method of claim 1, wherein in response to that the wireless communication terminal receives a configuration of the one or more DL signal transmissions and the wireless communication terminal does not receive the indication information associated with the one or more DL signal transmissions in a predefined resource, the wireless communication terminal performs at least one of:
performing operations relating to that the one or more DL signal transmissions are not available during a specific resource;
performing operations relating to that the one or more DL signal transmissions are available during a specific resource; or
performing operations relating to that the one or more DL signal transmissions are available or not available during a specific resource based on a higher layer parameter;
wherein in response to that the wireless communication terminal receives a configuration of the one or more DL signal transmissions and the wireless communication terminal does not receive an associated with the one or more DL signal transmissions in the modification period, the wireless communication terminal performs at least one of:
keeping acquiring SIB information during a next sequential modification period; or
performing operations relating to that the one or more DL signal transmissions are available during a specific resource; or
stopping acquiring SIB information and performing operations relating to that the one or more DL signal transmissions are not available;
wherein in response to that the wireless communication terminal is configured with a change of the one or more DL signal transmissions, and the wireless communication terminal does not receive information associated with the one or more DL signal transmissions from an acquired SIB during a modification period after another modification period where system information of the change or a DL signal transmission configuration is received, the wireless communication terminal performs at least one of:
keeping acquiring SIB information during a next sequential modification period; or
stopping acquiring SIB information and performing operations relating to that the one or more DL signal transmissions are not available;
wherein in response to that the wireless communication terminal is configured with the one or more DL signal transmissions, the wireless communication terminal does not receive any DL signal during a valid time for the one or more DL signal transmissions, the wireless communication terminal performs at least one of:
using a configuration of a last recent transmission or measurement of another DL signal in a PDCCH or PDSCH reception;
using a default pattern or a default configuration for the one or more DL signal transmissions; or
receiving the one or more DL signals during one or more additional validity durations or periodicities or modification periods.

9. The wireless communication method of claim 1, wherein a priority level for the one or more DL signal transmissions is configured for collisions between the one or more DL signal transmissions and other signals or channels;
wherein the wireless communication terminal supports at least one of: the one or more DL signal transmissions, a request or feedback for a DL signal transmission configuration, or an SCell without SSB for an inter-band carrier aggregation (CA).

10. The wireless communication method of claim 1, wherein the DL signals comprise a cell defining SSB (CD-SSB), and a non cell defining SSB (NCD-SSB), the transmission pattern comprises an offset between the CD-SSB and the NCD-SSB;
wherein the offset comprises at least one of:
{sf30, sf40, sf60, sf80, sf120}, or
{¼, ½, ¾}, or
{sf30, sf40, sf60, sf80, sf120, ¼, ½, ¾}; or
wherein the offset comprises:
{sf5, sf10, sf15, sf30, sf40, sf60, sf80, sf120},
{sf5, sf10, sf15, sf30, sf60, spare3, spare2, spare1},
{sf5, sf10, sf15, sf30, sf60, sf120, spare2, spare1},
{sf5, sf10, sf15, ¼, ½, ¾, spare2, spare1}, or
{sf5, sf10, sf15, ½, ¾, spare3, spare2, spare1}.

11. A wireless communication method comprising:
transmitting, by a wireless communication node to a wireless communication terminal, indication information of one or more downlink (DL) signal transmissions, wherein the indication information indicates one or more transmission patterns for the one or more DL signal transmissions; and
transmitting, by the wireless communication node to the wireless communication terminal, one or more DL signals according to the one or more patterns for the one or more DL signal transmissions.

12. The wireless communication method of claim 11, wherein the indication information comprises at least one of:
an indication of an availability or unavailability of one or more validity durations for the one or more DL signal transmissions;
an indication of an availability or unavailability of one or more DL signal bursts;
a change of the one or more DL signal transmissions;
a configuration of the one or more DL signal transmissions;
a value of a validity duration or an invalid duration;
a start position of the validity duration;
a gap for ignoring the one or more DL signal transmissions;
a periodicity or duration for the one or more DL signal transmissions;
a start offset of the validity duration or a periodicity for the one or more DL signal transmissions;
a number of available or unavailable DL signals;
a resource set for the one or more DL signal transmissions;
a paging occasion (PO) offset for the one or more DL signal transmissions;
a value of a system frame number (SFN), or a value of a paging frame (PF) index as a reference point of a valid time for the one or more DL signal transmissions;
an index of a pattern among the one or more patterns for the one or more DL signal transmissions;
a de-activation or unavailability of one or more validity durations or periodicities for the one or more DL signal transmissions;
an indication of no transmission of the one or more DL signals;
a stop or unavailability of at least one of the one or more DL signals; or
a hybrid automatic repeat request acknowledgment (HARQ-ACK) feedback for receiving the indication information;
wherein the value of PF index is not larger than a value of an Extended Discontinuous Reception (eDRX) cycle or a default paging cycle over 10 milliseconds;
wherein the one or more DL signals comprises at least one of:
a Synchronization Signal Block (SSB);
a cell defining (CD) SSB or non cell-defining (NCD) SSB;
an SSB being available during a validity duration for the wireless communication terminal;
a Primary Synchronization Signal (PSS) or Secondary Synchronization Signal (SSS);
a Tracking Reference Signal (TRS);
a channel status information reference signal (CSI-RS); or
a paging signal;
wherein the one or more DL signals are used for at least one of: a synchronization, an automatic gain control (AGC) adjustment, a beam management, a beam sweeping, a channel status information (CSI) measurement, a radio link monitoring measurement, a Radio Resources Management (RRM) measurement, or an energy saving for the wireless communication node.

13. The wireless communication method of claim 11, wherein the one or more transmission patterns comprises at least one of:
a valid time or invalid time;
a validity duration;
a start position or a boundary of the validity duration;
a modification period for the one or more DL signal transmissions;
a DL signal transmission occasion; or
a resource set;
wherein the valid time or invalid time is determined based on at least one of: a start point, an end position, a duration of the valid time or invalid time, a Discontinuous Reception (DRX) cycle, an indication of an availability of a validity duration or available DL signals, or an indication of an unavailability of a validity duration or unavailable DL signals;
wherein at least one of the start point or the end position is determined based on at least one of a PF offset, a periodicity for the one or more DL signal transmissions, an eDRX cycle, a default paging cycle, a DRX cycle, or a modification period;
wherein the duration of the valid time or invalid time is determined based on at least one of: a multiple of a periodicity or a validity duration for the one or more DL signal transmissions, or a certain number of sequential symbols or slots;
wherein the validity duration is a number of eDRX cycles, default paging cycles, or DRX cycles;
wherein a start position of the validity duration is determined based on at least one of: a position of a first PF during an eDRX cycle or a paging cycle, a predetermined system frame number (SFN) or a delay after a reception of the indication information;
wherein a boundary of the validity duration is determined based on at least one of: a gap or a position that receiving the indication information of the one or more DL signal transmissions;
wherein the gap is a period before a PF, PO, SFN, slot, or symbol that the wireless communication terminal receives the indication information of the one or more DL signal transmissions, and the wireless communication terminal is not allowed to receive the one or more DL signals in the gap.

14. The wireless communication method of claim 13, wherein the wireless communication node transmits a configuration of the one or more DL signal transmissions to the wireless communication terminal in a first modification period, transmits the indication information in a second modification period adjacent to the first modification period, and receives the one or more DL signals in a third modification period adjacent to the transmits modification period;
wherein a boundary of the modification periods is determined based on at least one of a period value or an offset;
wherein a boundary of the DL signal transmission occasion is determined based on a PO offset.

15. The wireless communication method of claim 13, wherein the resource set comprises at least one of: a first resource set for a basic pattern, a second resource set for a normal pattern, a third resource set for a pattern configured by a system information block (SIB) or a fourth resource set for a UE specific pattern;
wherein at least one of the first or third resource set is determined based on at least one of: a validity duration, a start position of validity duration, a number of available DL signals, a PO offset, or a modification period;
wherein at least one of the first or third resource set is configured for a UE in an idle-mode;
wherein at least one of the second or fourth resource set is determined based on at least one of: a validity duration, a start position of validity duration, a number of available DL signals, a PO offset, a modification period, a DRX cycle, a periodicity, or a duration;
wherein at least one of the second or fourth resource set is configured for a UE in a connected-mode.

16. The wireless communication method of claim 11, wherein the indication information is indicated by at least one of: Cell-specific DCI, Group-common DCI, UE-specific DCI, a Medium Access Control Control Element (MAC CE), Radio Resource Control (RRC) signaling, or an SIB;
wherein the Cell-specific DCI comprises at least one of: an information block comprising an indication for the one or more DL signal transmissions for all UEs in one or more cells or one or more cell groups, a bitmap field comprising one or more indications for the one or more DL signal transmissions for all UEs in one or more cells or one or more cell groups, or an indication field comprising an indication for the one or more DL signal transmissions for all UEs in a cell or a cell group;
wherein the one or more cell groups supports at least one of: same eDRX parameters, a same default paging cycle, or a same DRX cycle;
wherein the Group-common DCI comprises at least one of: an information block configured for a UE in a group of UEs; an information block configured for a group of UEs; or a bitmap, wherein each bit is configured for one or more groups of UEs;
wherein the group of UEs supports at least one of: having valid POs in a same PF, or having valid POs in a number of sequential PF during an eDRX cycle or a default paging cycle.

17. The wireless communication method of claim 16, wherein the Group-common DCI indicates the indication information in at least one field of: a slot format indicator, an available resource block, RB, set indicator, or a channel occupancy time, COT, duration indicator, a search space set group switching flag, a pre-emption indication, a wake-up indication, a secondary cell (SCell) dormancy indication, a paging indication, or a TRS availability indication;
wherein the UE-specific DCI comprises at least one of: a bitmap to indicate an availability of one or more validity durations or periodicities for the one or more DL signal transmissions, or an indication field indicating at least one of: a reference point, a start SFN, a slot, a symbol for a validity duration or the DL signal transmission;
wherein the UE-specific DCI indicates the indication information in at least one field of: a frequency domain resource assignment, a time domain resource assignment, a modulation and coding scheme, a new data indicator, a redundancy version, an HARQ process number, an uplink or supplementary uplink (UL/SUL) indicator, an HARQ-ACK bitmap, an indicator of all remaining bits used for configured grant downlink feedback information (CG-DFI), a redundancy version, a random access preamble index, a synchronization signal/physical broadcast channel (SS/PBCH) index, a physical random access channel (PRACH) mask index, reserved bits, a downlink assignment index, a physical uplink control channel (PUCCH) resource indicator, a field of short messages, a TRS availability indication, a physical downlink shared channel (PDSCH) group index, an HARQ-ACK retransmission indicator, or an SCell dormancy indication;
wherein the RRC signaling comprises at least one of: parameters of the one or more DL signal transmissions configured for a cell or a group of cells, or parameters of the one or more DL signal transmissions configured for a UE or a group of UEs;
wherein the SIB comprises at least one of:
an index of one of the one or more DL signals;
an availability of one or more validity durations of the one or more DL signal transmissions;
an availability of at least one of the one or more DL signals;
parameters associated with DL signal transmission occasions;
a number of RBs or orthogonal frequency-division multiplexing (OFDM) symbols occupied by the one or more DL signals;
a periodicity or duration for the one or more DL signal transmissions;
a start offset for a validity duration or a periodicity for the one or more DL signal transmissions;
a start position or reference point for a validity duration or for the one or more DL signals;
an indication indicating whether the one or more DL signal transmissions are configured, started, or stopped;
an indication indicating whether the one or more DL signal transmissions are valid; or
an indication indicating whether another signal transmission is deactivated.

18. The wireless communication method of claim 11, wherein a priority level for the one or more DL signal transmissions is configured for collisions between the one or more DL signal transmissions and other signals or channels;
wherein the wireless communication terminal supports at least one of: the one or more DL signal transmissions, a request or feedback for a DL signal transmission configuration, or an SCell without SSB for an inter-band carrier aggregation, CA.

19. The wireless communication method of claim 11, wherein the DL signals comprise a cell defining SSB (CD-SSB), and a non cell defining SSB (NCD-SSB), the transmission pattern comprises an offset between the CD-SSB and the NCD-SSB;
wherein the offset comprises at least one of:
{sf30, sf40, sf60, sf80, sf120}, or
{¼, ½, ¾}, or
{sf30, sf40, sf60, sf80, sf120, ¼, ½, ¾}; or
wherein the offset comprises:
{sf5, sf10, sf15, sf30, sf40, sf60, sf80, sf120},
{sf5, sf10, sf15, sf30, sf60, spare3, spare2, spare1},
{sf5, sf10, sf15, sf30, sf60, sf120, spare2, spare1},
{sf5, sf10, sf15, ¼, ½, ¾, spare2, spare1}, or
{sf5, sf10, sf15, ½, ¾, spare3, spare2, spare1}.

20. A wireless communication terminal, comprising:
a communication unit; and
a processor configured to: receive, from a wireless communication node, indication information of one or more downlink (DL) signal transmissions, wherein the indication information indicates one or more transmission patterns for the one or more DL signal transmissions; and receive, from the wireless communication node, one or more DL signals according to the one or more patterns for the one or more DL signal transmissions.
